(19) United States
(12) Patent Application Publication
(10) Pub. No.: US 2003/0168921 A1
(43) Pub. Date: Sep. 11, 2003

(54) Continuous electrical generator

(76) Inventor: Alberto Molina-Martinez, West Palm Beach, FL (US)

Correspondence Address: WILLIAMS MULLEN, 1 OLD OYSTER POINT ROAD, SUITE 210, NEWPORT NEWS, VA, 23602, US

(21) Appl. No.: 10/351,806

(22) Filed: Jan. 27, 2003

Related U.S. Application Data
(63) Continuation of application No. 10/091,863, filed on Mar. 6, 2002, now abandoned.

(51) Int. Cl. H02P 15/00

(52) U.S. Cl. 310/103

(57) ABSTRACT

A stationary cylindrical electromagnetic core, made of one piece thin laminations stacked to desired height, having closed slots radially distributed, where two three-phase winding arrangements are placed together in the same slots, one to the center, one to the exterior, for the purpose of creating a rotational electromagnetic field by applying temporarily a three-phase current to one of said windings, and by this means, inducting a voltage on the second one, in such a way that the outgoing energy is a lot greater than the input. A return will feedback the system and the temporary source is then disconnected. The generator will run by itself indefinitely generating a great excess of energy permanently.

### CROSS REFERENCE TO RELATED APPLICATION

The present application claims priority from U.S. Provisional Application Ser. No. 60/139,294, filed Jun. 15, 1999.

### BACKGROUND OF THE INVENTION

1. Field of the Invention

The present invention relates generally to, electrical power generating systems. More specifically, the present invention relates to self-feeding electrical power generating units.

2. Description of Related Art

Since Nikola Tesla invented and patented his Polyphase System for Generators, Induction Motors and Transformers, no essential improvement has been made in the field. The generators would produce the polyphase voltages and currents by means of mechanical rotational movement in order to force a magnetic field to rotate across the generator's radially spaced windings. The basis of the induction motor system was to create an electro-magnetically rotating field, instead of a mechanically rotated magnetic field, which would induce voltages and currents to generate electromotive forces usable as mechanical energy or power. Finally, the transformers would manipulate the voltages and currents to make them feasible for their use and transmission for long distances.

In all present Electric Generators a small amount of energy, normally less than one percent of the outgoing power in big generators, is used to excite the mechanically rotated electromagnetic poles that will induce voltages and currents in conductors having a relative speed or movement between them and the polar masses.

The rest of the energy used in the process of obtaining electricity, is needed to move the masses and to overcome the losses of the system: mechanical losses; friction losses; brushes losses, windage losses; armature reaction losses; air-gap losses; synchronous reactance losses; eddy current losses; hysteresis losses, all of which, in conjunction, are responsible for the excess in power input (mechanical power) required to generate always smaller amounts of electric power.

### SUMMARY OF THE INVENTION

The Continuous Electrical Generator consists of a stationary cylindrical electromagnetic core made of one piece thin laminations stacked together to form a cylinder, where two three-phase windings arrangements are placed in the same slots not having any physical relative speed or displacement between them. When one of the windings is connected to a temporary three-phase source, an electromagnetic rotating field is created, and the field this way created will cut the stationary coils of the second winding, inducting voltages and currents. In the same way and extent as in common generators, about one percent or less of the outgoing power will be needed to keep the rotational magnetic field excited.

In the Continuous Electrical Generator there are no mechanical losses; friction losses; brushes losses; windage losses; armature reaction losses; or air gap losses, because there is not any movement of any kind. There are: synchronous reactance losses, eddy current losses and hysteresis losses, which are inherent to the design, construction and the materials of the generator, but in the same extent as in common generators.

One percent or less of the total energy produced by present electric generators goes to create their own magnetic field; a mechanical energy that exceeds the total output of present generators is used to make them rotate in the process of extracting electrical currents from them. In the Continuous Electrical Generator there is no need for movement since the field is in fact already rotating electro-magnetically, so all that mechanical energy will not be needed. Under similar conditions of exciting currents, core mass and windings design, the Continuous Electrical Generator is significantly more efficient than present generators, which also means that it can produce significantly more than the energy it needs to operate. The Continuous Electrical Generator can feedback the system, the temporary source may be disconnected and the Generator will run indefinitely.

As with any other generator, the Continuous Electrical Generator may excite its own electromagnetic field with a minimum part of the electrical energy produced. The Continuous Electrical Generator only needs to be started up by connecting its inducting three-phase windings to a three-phase external source for an instant, and then to be disconnected, to start the system as described herein. Then, disconnected, it will run indefinitely generating a great excess of electric power to the extent of its design.

The Continuous Electrical Generator can be designed and calculated with all mathematical formulas in use today to design and calculate electrical generators and motors. It complies with all of the laws and parameters used to calculate electrical induction and generation of electricity today.

Except for the Law of Conservation of Energy, which, by itself, is not a mathematical equation but a theoretical concept and by the same reason does not have any role in the mathematical calculation of an electrical generator of any type, the Continuous Electrical Generator complies with all the Laws of Physics and Electrical Engineering. The Continuous Electrical Generator obligates us to review the Law of Conservation of Energy. In my personal belief, the electricity has never come from the mechanical energy that we put into a machine to move the masses against all oppositions. The mechanical system is actually providing the path for the condensation of electricity. The Continuous Electrical Generator provides a more efficient path for the electricity.

### DESCRIPTION OF DRAWINGS

FIG. 1 shows one embodiment of the present invention.

FIG. 2 shows an internal wiring diagram for the embodiment of the present invention shown in FIG. 1.

FIG. 3 shows a single laminate for an alternate embodiment of the present invention.

FIG. 4 shows a two-piece single laminate for another alternate embodiment of the present invention.

FIG. 5 shows a wiring diagram for an embodiment of the present invention constructed from the laminate shown in FIG. 3 or FIG. 4.

FIG. 6 shows the magnetic flux pattern produced by the present invention.

FIG. 7 shows the rotational magnetic field patterns produced by the present invention.

FIG. 8 shows the complete system of the present invention.

FIG. 9 is an expanded view of the alternate embodiment of the present invention shown in FIG. 3 or 4.

### DETAILED DESCRIPTION OF THE INVENTION

The present invention is a Continuous and Autonomous Electrical Generator, capable of producing more energy than it needs to operate, and which provides itself the energy needed to operate. The basic idea consists in the induction of electric voltages and currents without any physical movement by the use of a rotational magnetic field created by a three-phase stator connected temporarily to a three-phase source, and placing stationary conductors on the path of said rotational magnetic field, eliminating the need of mechanical forces.

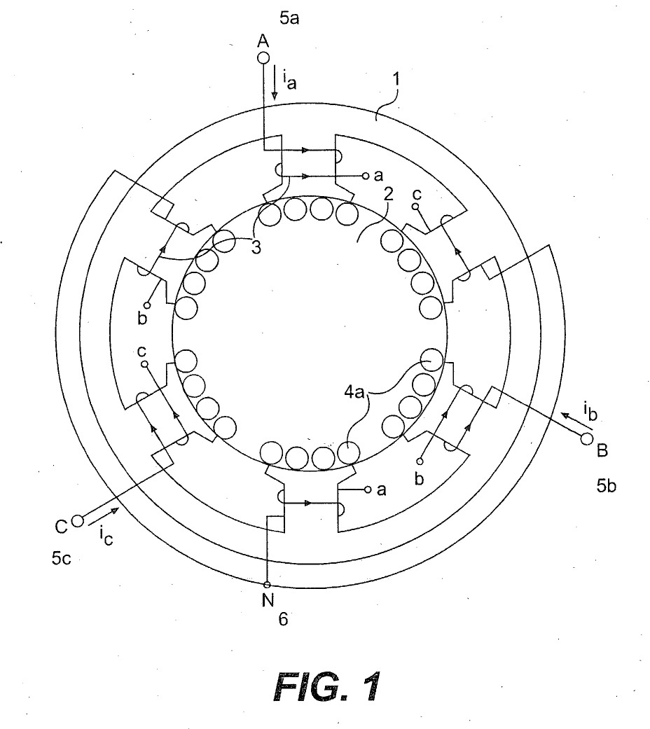

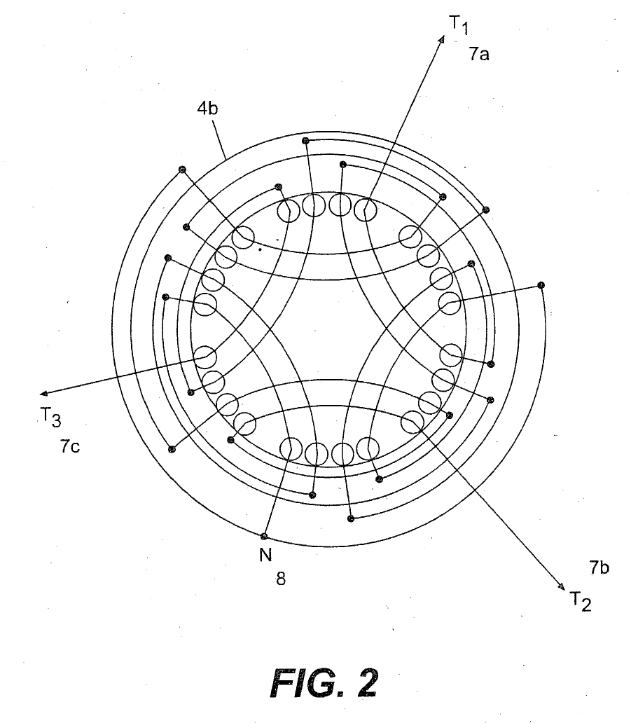

The basic system can be observed in FIG. 1, which shows one embodiment of the present invention. There is a stationary ferromagnetic core 1 with a three-phase inducting windings 3, spaced 120 degrees and connected in wye 6 in order to provide a rotating electromagnetic field, when a three-phase voltage is applied; for the case, a two-pole arrangement. Inside this core 1 there is a second stationary ferromagnetic core 2, with no space between them, this is, with no air-gap. This second core 2 has also a three-phase stationary winding arrangement 4a (in FIG. 1) 4b (in FIG. 2), aligned as shown in FIGS. 1 and 2 with the external core inducting windings 3. There is not any movement between the two cores, since there is no air-gap between them. There is no shaft on either core since these are not rotating cores. The two cores can be made of stacked insulated laminations or of insulated compressed and bonded ferromagnetic powder. The system works either way, inducting three-phase voltages and currents on the stationary conductors 4a of the internal windings 4b, applying three-phase currents to terminals A 5a, B 5b and C 5c of the external windings 3; or inducting three-phase voltages and currents on the external windings 3, by applying three-phase currents to the terminals T1 7a, T2 7b and T3 7c, of the internal windings 4b. When a three-phase voltage is applied to terminals A 5a, B 5b and C 5c, the currents will have the same magnitude, but will be displaced in time by an angle of 120 degrees. These currents produce magneto motive-forces, which, in turn, create a rotational magnetic flux. The arrangements may vary widely as they occur with present alternators and three-phase motors, but the basics remain the same, a stationary but electro-magnetically rotating magnetic field, inducting voltages and currents on the stationary conductors placed on the path of said rotating magnetic field. The diagram is showing a two-pole arrangement for both windings, but many other arrangements may be used, as in common generators and motors.

FIG. 2 shows the three-phase arrangement of the internal winding 4b which has provided, in practice, symmetrical voltages and currents, due to a space angle of 120 degrees. It is similar to a two-pole arrangement. Many other three-phase or poly-phase arrangements may be used. Wherever a conductor is crossed by a rotational magnetic field, a voltage will be induced across its terminals. The interconnections depend on the use that we will give to the system. In this case, we will have a three-phase voltage in terminals T1 7a, T2 7b and T3 7c and a neutral 8. The outgoing voltage depends on the density of the rotational magnetic flux, the number of turns of the conductor, the frequency (instead of the speed) and the length of the conductor crossed by the field, as in any other generator.

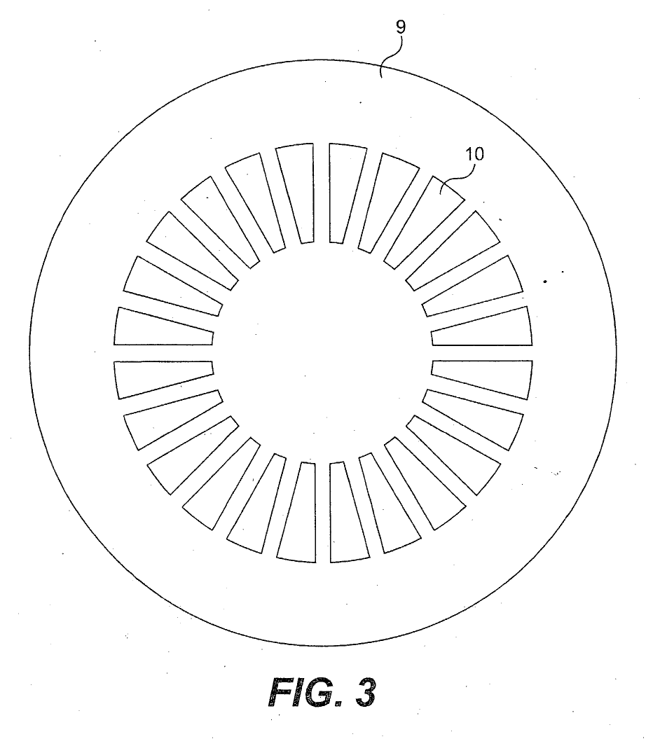

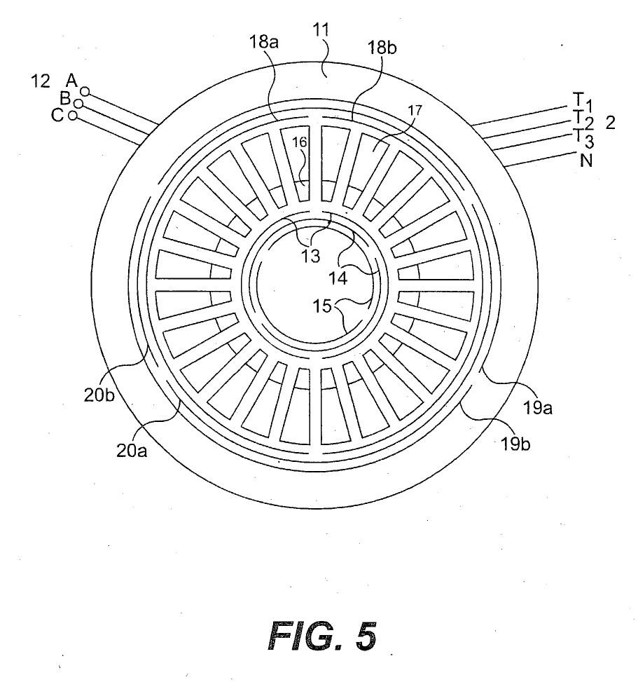

FIG. 3 shows an alternate embodiment of the present invention in which the generator is made from multiple one-piece laminations 9, stacked as a cylinder to the desired height. This embodiment can also be made of a one-piece block of compressed and bonded insulated ferromagnetic powder. The same slot 10 will accommodate the internal 4a/4b and the external windings 3, that is, the inducting and the induced windings (see FIG. 5). In this case, a 24-slot laminate is shown, but the number of slots may vary widely according to the design and needs.

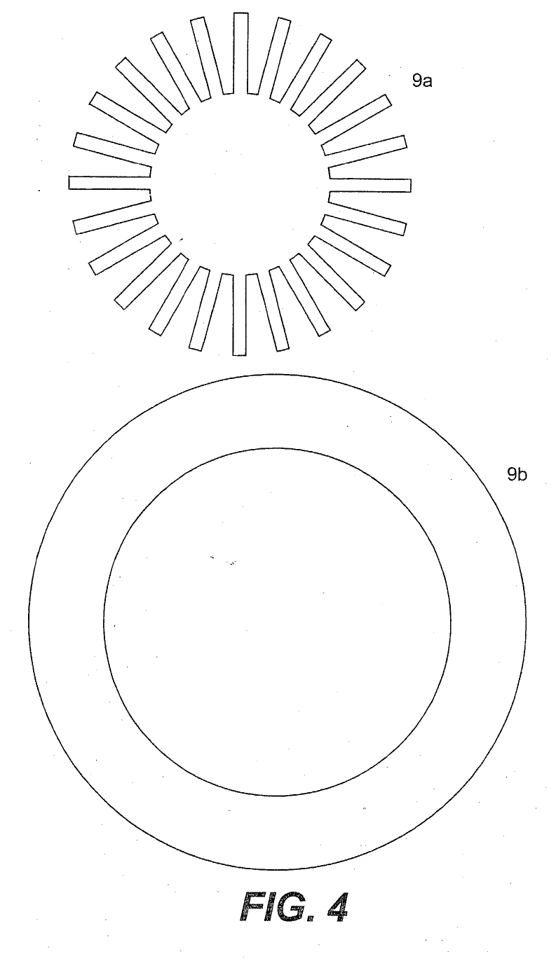

FIG. 4 shows a two-piece single laminate for another alternate embodiment of the present invention. For practical effects the lamination can be divided into two pieces 9a, 9b, as shown, to facilitate the insertion of the coils. Then, they are solidly assembled without separation between them, as if they were only one piece.

The laminates described above may be constructed with thin (0.15 mm thick or less) insulated laminations 9 or 9a and 9b of a high magnetic permeability material and low hysteresis losses such as Hiperco 50A or similar to reduce losses or with compressed electrically isolated ferromagnetic powder, which has lower eddy current losses and also may have low hysteresis losses, which can make the generator highly efficient.

OPERATING THE GENERATOR. The Continuous Electrical Generator as described and shown in the following drawings is designed and calculated to produce a strong rotating electromagnetic field with low exciting currents. By using a laminated material, such as the said Hiperco 50A, we can achieve rotating magnetic fields above two Teslas, since there are no air gap losses, mechanical losses, windage losses, armature reaction losses, etc. as said before. This may be obtained by applying a temporary three-phase current to the terminals A, B and C 12 of the inducting coils 13, 14 and 15 (5a, 5b and 5c in FIG. 1), spaced 120 degrees from each other (see FIG. 5).

FIG. 5 shows the spatial distribution of the inducting windings 13, 14 and 15, as well as the induced windings 18a, 18b, 19a, 19b, 20a and 20b. Both, the inducting and the induced windings are placed in the same slots 10 or 16 and. 17, with similar arrangements. Even though the system works in both directions, the better configuration seems to be to place the inducting windings 13, 14 and 15, to the center and the induced windings 18a, 18b, 19a, 19b, 20a and 20b, to the exterior, since small windings will be needed to induce a very strong rotational magnetic field, due to the small losses involved in the process, and in exchange, bigger and powerful windings will be needed to extract all the energy that the system will provide. Both windings are connected in wye (not shown), but they can be connected in different ways, as any other generator. These arrangements are equivalent to the arrangements shown for the embodiment in FIGS. 1 and 2.

The inducting coils 13, 14 and 15 are designed and calculated so that the generator may be started with common three-phase lines voltages (230 Volts 60 Hz per phase, for example). If the local lines voltages are not appropriate, we can control the voltage to the designed level by means of a three-phase variable transformer, an electronic variator or inverter etc. Once we have such strong magnetic field rotating and crossing the stationary induced coils 18a, 18b, 19a, 19b, 20a and 20b, a three-phase voltage will be induced across terminals T1, T2, T3 and N 21 in proportion to the magnetic flux density, the number of turns in the coils, the frequency used (instead of the speed), the length of the conductors cut by the rotating field, as in any other alternator. We can connect, as we desire in wye or delta, etc., as in any other alternator or generator. The outgoing currents will be three-phase currents (or poly-phase currents depending on the arrangement) and we can have a neutral 21 if we are using a wye connection, as in any other alternator.

The outgoing alternate voltages and currents are perfect sinusoidal waves, perfectly spaced in time, and totally symmetrical. The voltages and currents obtained by this method are usable in any conventional manner. Any voltage can be produced, depending on the design.

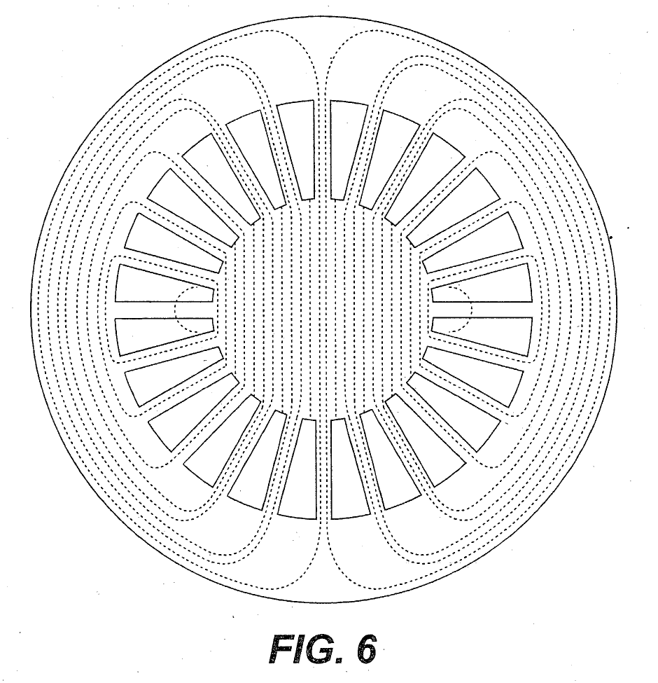

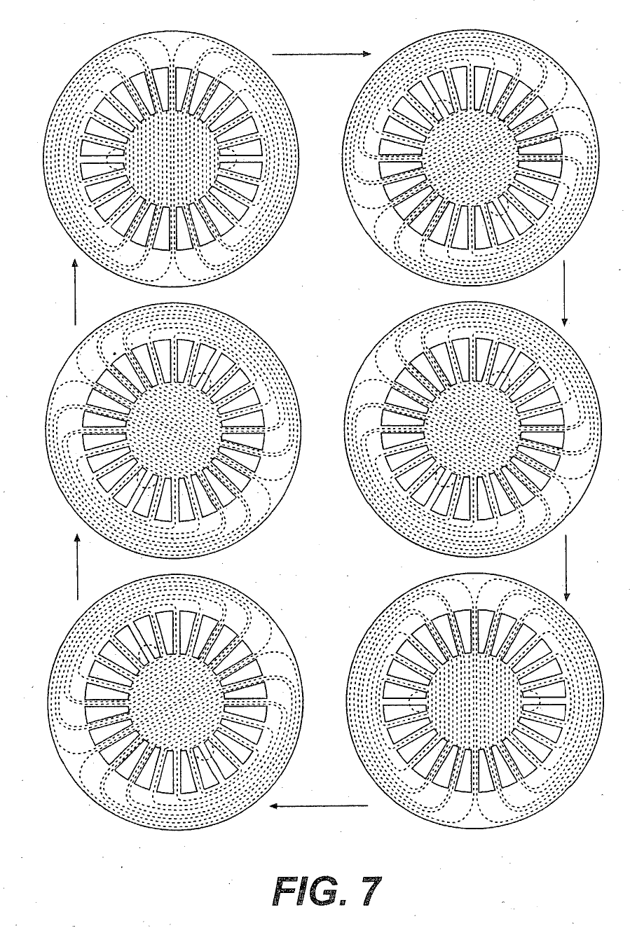

FIG. 6 shows the magnetic flux pattern produced by the three-phase inducting windings 13, 14 and 15. This pattern is similar to the pattern of an induction motor's stators. Since there is no air gap; the whole path for the magnetic flux is homogeneous with no change in materials. The core is made of thin insolated laminations of a high magnetic permeability and low hysteresis loss material; eddy current losses are minimal due to the thin lamination. There are no counter fluxes or armature reactions thus the magnetic flux may be near to saturation with a small exciting current or input energy. Due to the time differential between the three phases and the spatial distribution of the inducting windings, a rotational magnetic field will be created in the core, as shown in FIG. 7.

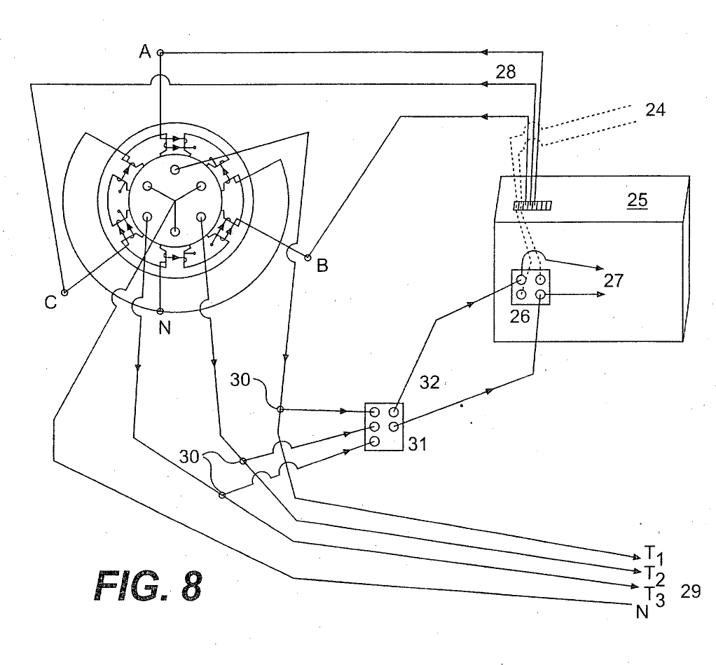

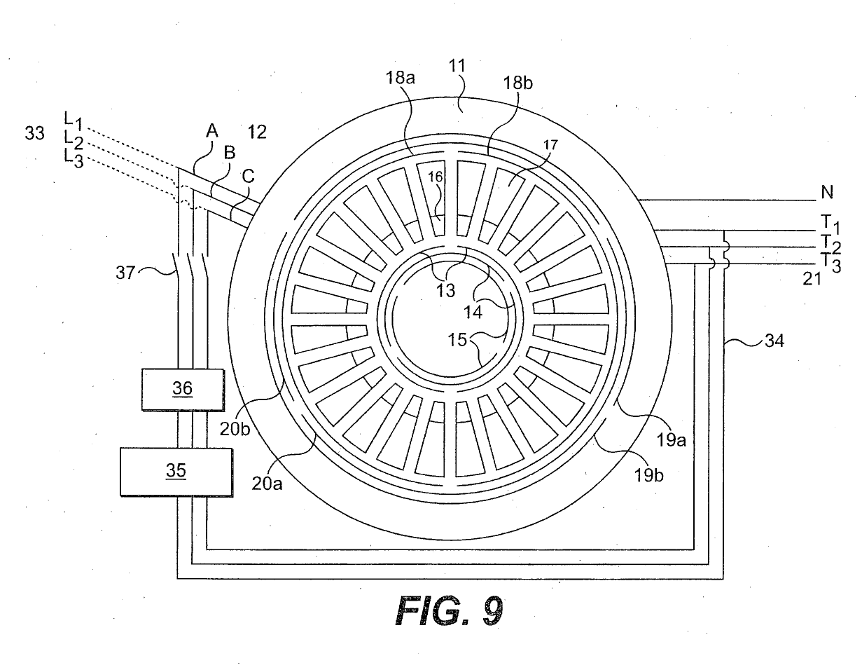

Once the generator is started, a small part of the energy obtained is sent back (FIGS. 8 and 9) to feed the inducting coils 3 (in FIG. 1) or 13, 14 and 15 (in FIG. 5), as in any other auto-excited alternator or generator. Of course voltages and phases should be perfectly identical and aligned, and if necessary the feedback voltages should be controlled and handled by means of variable transformers, electronic variators, phase shifters (to align phases) or other type of voltage or phase controllers.

One possible method consists of the use of an electronic converter or variator 25 which initially converts two or three lines of alternating current 24 to direct current by an electronic rectifier 26 and then, electronically, converts the direct current 27 to three-phase current 28 to supply three-phase currents spaced in time 120 degrees for the electromagnetic fields A, B and C 3. Some variators or converters can accept two lines of voltage, while others will accept only a three-phase line voltage. This embodiment uses a variator of 3 kva that accepts two 220-volt lines.

The rotational magnetic field-created by the currents going through the inducting three-phase windings 13, 14 and 15, will induce a voltage across the terminals T1, T2, T3, N, 29 (7a, 7b, 7c, 8 in FIG. 2). Then, from the outgoing current lines 29, a derivation is made 30 to feed back the system, converting the feed back alternate currents, by means of electronic diode rectifiers 31, to direct current 32 and then feed back the electronic converter or variator 25 to the dc terminals of the electronic rectifier 26 (See FIG. 8). Once the feedback is connected, the Continuous Electrical Generator may be disconnected from the temporary source 24, and will continue generating electric energy indefinitely.

In FIG. 9, an alternate embodiment of the Continuous Electrical Generator can be observed. The basic principles remain the same as for the embodiment described above and shown in FIGS. 1 and 2. The basic differences are in the shape of the laminations and the physical distribution of the windings, as discussed and shown previously. A variation of the feedback, using a variable and shifting transformers is also shown.

The ferromagnetic core 11 is made of one-piece laminates 9 as shown in FIG. 3 (or two for convenience 9a, 9b as shown in FIG. 4) stacked to the desired height. The slots 10, as indicated before, will accommodate both the inducting 13, 14 and 15 and the induced 18a-b, 19a-b and 20a-b windings in the same slot 10 or 16 and 17. The incoming three phase lines 12 feed the inducting three-phase windings 13, 14 and 15. They are fed, initially by the temporary source 33 in the first instance, and by the three-phase return 34 once the generator is running by itself.

The inducting windings 13, 14 and 15 have a two-pole arrangement, but many other three-phase or poly-phase arrangements can be made to obtain an electromagnetic rotating field. These windings are connected in wye (not shown) in the same way shown for the embodiment shown in FIGS. 1, 2 and 8, but may be connected in many different ways. The inducting windings 13, 14 and 15 and located in the internal portion 16 of the slot 10.

The induced windings 18a-b, 19a-b and 20a-b have a two-pole arrangement, exactly equal to the arrangement for the inducting windings 13, 14 and 15, but many other arrangements can be made depending on the design and the needs. The induced windings must be calculated in a way that the generator will have the lowest possible synchronous reactance and resistance. In this way, most of the outgoing power will go to the charge instead of staying to overcome the internal impedance. These windings are connected in wye to generate a neutral 21, in the same way shown in the embodiment of the present invention shown in FIG. 2, but may be connected in different ways according to the needs. The induced windings 18a-b, 19a-b and 20a-b are located in the external portion 17 of the slot 10.

The outgoing three-phase and neutral lines 21 come from the induced windings 18a-b, 19a-b and 20a-b. The rotational magnetic field created in the core (see FIGS. 6 & 7) by the inducting windings 13, 14 and 15, induces a voltage across the terminals T1, T2 and T3, plus a neutral, 29. From each of the three-phase outgoing lines 21, a return derivation 34 is made to feedback the system.

The temporary three-phase source 33 is temporarily connected to terminals A, B and C 12. The Continuous Electrical Generator must be started with an external three-phase source for an instant, and then disconnected.

Even though the return lines voltage can be calculated and obtained precisely by tabbing the induced windings at the voltage required by the inducting windings (according to the design), it may be convenient to place a three-phase variable transformer or other type of voltage controller 35 in the middle for more precise adjustment of the return voltage.

Placed after the variable transformer 35, the three-phase shifting transformer 36 will correct and align any phase shift in the voltage and currents angles, before the return is connected. This system functions similarly to the system shown in FIG. 8 which uses a variator or a converter 25.

Once the voltage and phases are aligned with the temporary source 33, the return lines 34 are connected to the incoming lines A, B and C 12 at feedback connection 37 and the temporary source 33 is then disconnected. The Continuous Electrical Generator will remain working indefinitely without any external source of energy, providing a great excess of energy permanently.

The outgoing electric energy provided by this system has been used to produce light and heat, run poly-phase motors, generate usable mono-phase and poly-phase voltages and currents, transform voltages and currents by means of transformers, convert the alternate outgoing poly-phase currents to direct current, as well as for other uses. The electricity obtained by the means described is as versatile and perfect as the electricity obtained today with common electric generators. But the Continuous Electrical Generator is autonomous and does not depend on any other source of energy but itself once it is running; may be carried anywhere with no limitations; it can be constructed in any size and provides any amount of electricity indefinitely, according to the design.

The Continuous Electrical Generator is and will be a very simple machine. The keystones of the systems reside in the ultra-low losses of a non-movement generation system, and in a very low synchronous reactance design.

The induced windings must be calculated in a way that the generator may have the lowest possible synchronous reactance and resistance. In this way, most of the outgoing power will go to the charge instead of staying to overcome the internal impedance.

What is claimed is:

1. A continuous electrical generator, comprising:
a core having a plurality of slots;
an inducing means for inducing a stationary, rotating electromagnetic field, said inducing means being located in the plurality of slots;
an induced means across which is induced electrical energy, said induced means being located in the plurality of slots; and
a power source to supply power to the inducing means.

2. The continuous electrical generator as described in claim 1 wherein the core is constructed as a unitary structure.

3. The continuous electrical generator as described in claim 1 wherein the core further comprises:
an internal section; and
an external section wherein the internal section and the external section are assembled together with no gaps or movement between the sections.

4. The continuous electrical generator as described in claim 1 wherein the core is constructed from a plurality of stacked laminates.

5. The continuous electrical generator as described in claim 1 wherein the core is made from bonded ferromagnetic powder which is compressed and insulated.

6. The continuous electrical generator as described in claim 1 wherein the core includes a cylindrical solid central portion.

7. The continuous electrical generator as described in claim 6 wherein the plurality of slots extends laterally from the cylindrical central portion towards the external edge of the core.

8. The continuous electrical generator as described in claim 1 wherein the inducing means is a first set of electrical windings.

9. The continuous electrical generator as described in claim 1 wherein the induced means is a second set of electrical windings.

10. The continuous electrical generator as described in claim 8 wherein the first set of electrical windings is in a two-pole arrangement.

11. The continuous electrical generator as described in claim 9 wherein the second set of electrical windings is in a two-pole arrangement.

12. The continuous electrical generator as described in claim 8 wherein the first set of electrical windings are three-phase inducing windings spaced 120 degrees apart.

13. The continuous electrical generator as described in claim 9 wherein the second set of electrical windings are three-phase induced windings spaced 120 degrees apart.

14. The continuous electrical generator as described in claim 7 wherein the inducing means is located in the slots near the cylindrical central portion.

15. The continuous electrical generator as described in claim 7 wherein the induced means is located in the slots distant from the cylindrical central portion.

16. The continuous electrical generator as described in claim 1 further comprising a feed back system for supplying power from the induced means to the generator.

17. The continuous electrical generator as described in claim 16 wherein the power source is removed once the feed back system is functioning to supply power to the generator.

18. The continuous electrical generator as described in claim 16 further comprising an adjusting means for adjusting the supplied power.

19. The continuous electrical generator as described in claim 16 further comprising a phase shifting means for aligning phase shifts in the supplied power.
